(19) United States
(12) Patent Application Publication
(10) Pub. No.: US 2006/0037839 A1
(43) Pub. Date: Feb. 23, 2006

(54) Alignment conveyor

(75) Inventor: Lawrence A. Ward, Collegeville, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Packaging Progressions, Inc., Collegeville, PA (US)

(21) Appl. No.: 11/206,592

(22) Filed: Aug. 18, 2005

Related U.S. Application Data
(60) Provisional application No. 60/603,119, filed on Aug. 20, 2004.

(51) Int. Cl. B65G 47/26

(52) U.S. Cl. 198/459.1

(57) ABSTRACT

An alignment conveyor adapted to align a row of products in a side-by-side fashion is provided. The products are aligned in an alignment region of the conveyor by causing, a reverse rotation of the rollers, thereby halting progress of the products in the run on the conveyor until the row of products are aligned. Thereafter, the aligned row continues down the conveyor for further processing or packaging.

### CROSS REFERENCE TO RELATED APPLICATION

This application claims the benefit of U.S. provisional application Ser. No. 60/603,119, filed on Aug. 20, 2004, which is incorporated by reference as if fully set forth.

### FIELD OF INVENTION

The present invention is generally directed to conveyors and, more specifically, to a conveyor that can generally align a row of products in a side by side fashion.

### BACKGROUND

Many manufacturing processes require the alignment of rows of products through various stations for processing and/or packaging. It is not uncommon for rows of product to become misaligned during processing. For example, when transporting rows of food items through a spiral cooking station, it is common for rows of food items to become misaligned. This can result in downstream inefficiencies and difficulties in further processing or packaging.

It would be advantageous to provide a conveyor and/or a method for aligning one or more rows of products in a side-by-side fashion on a conveyor that can preferably align multiple rows of products without interrupting the transport and/or processing of the products.

### SUMMARY

The present invention is an alignment conveyor adapted to align a row of products in a side by side fashion. The alignment conveyor according to the present invention includes a plurality of free rolling rollers, having sufficient width to hold a row of products in a generally side by side arrangement, and connected together to define a conveyor path. The alignment conveyor also includes a conveyor mechanism for transporting the free rolling rollers in a direction of the conveyor path, and an alignment region. The alignment region includes an upstream area containing an acceleration mechanism and a downstream area containing a deceleration mechanism. The acceleration mechanism works to accelerate the products by rotating the rollers, located in the upstream area, in the same direction as the conveyor is moving. The deceleration mechanism works to decelerate the row of products on the conveyor by rotating the rollers, located in the downstream area, in an opposite direction to the direction that the conveyor is traveling.

The present invention also presents a method for aligning a row of products on a conveyor including the following steps. First, moving the row of products down the conveyor toward an alignment region. Then, rotating the rollers in a downstream area of the alignment region so that the product supporting surface of the rollers moves in a direction opposite to the conveyor. Then, continuing to rotate the rollers in the down stream area until the products in the first row are in an aligned side-by-side arrangement. Once the products are aligned in a side-by-side arrangement, the row of products continues down the conveyor path. The process can be repeated to align a second and subsequent rows of products.

### BRIEF DESCRIPTION OF THE DRAWINGS

The following detailed description of the preferred embodiment of the present invention will be better understood when read in conjunction with the appended drawings. For the purpose of illustrating the invention, there are shown in the drawings an embodiment which is presently preferred. It is understood, however, that the invention is not limited to the precise arrangement and instrumentalities shown. In the drawings:

FIG. 1 is a top plan view of a preferred embodiment of an alignment conveyor according to the present invention positioned to receive product from a conventional conveyor;

FIG. 2 is a side elevational view of the alignment conveyor of FIG. 1 showing product about to be dispensed onto the alignment conveyor;

FIG. 3 is a top plan view of the alignment conveyor of FIG. 1 illustrating first and second product rows (which are misaligned) being transported along a conventional conveyor toward the alignment conveyor of the present invention;

FIG. 4 is a top plan view of the alignment conveyor of FIG. 1 and illustrates the spacing between the first and second product rows having increased due to the first product row having been transported over acceleration racks; and

FIG. 5 is a top plan view of the alignment conveyor of FIG. 1 illustrating the first product row generally aligned with each other in a side-by-side manner (due to the temporary neutralization of forward momentum of the products in the row); the neutralization of forward momentum is caused by the temporary engagement of a deceleration rack with those rollers positioned within a selected portion of a conveyor path; once a row of products is properly aligned, the deceleration rack disengages to allow the properly aligned product row to continue transport along the conveyor for further processing and/or packaging.

### DETAILED DESCRIPTION OF THE PREFERRED EMBODIMENT(S)

Certain terminology is used in the following description for convenience only and is not limiting. The words “right,” “left,” top” and “bottom” designate directions in the drawings to which reference is made. The words “inwardly” and “outwardly” refer to directions towards and away from, respectively, the geometric center of the alignment conveyor 10 and designated parts thereof. The term “alignment region” means the area defined by the rollers that are affected by the acceleration mechanism and deceleration mechanism 20. The term “upstream area” means “the area defined by the rollers 16 that are affected by the acceleration rack(s) 14. The “downstream area” means the rollers that are affected by the deceleration mechanism 20. The words “a,” “and,” “one” as used in the claims and in the corresponding portions of the specification, are defined as including one or more of the referenced item unless specifically stated otherwise. This terminology includes the words above specifically mentioned, derivatives thereof, and words of similar import.

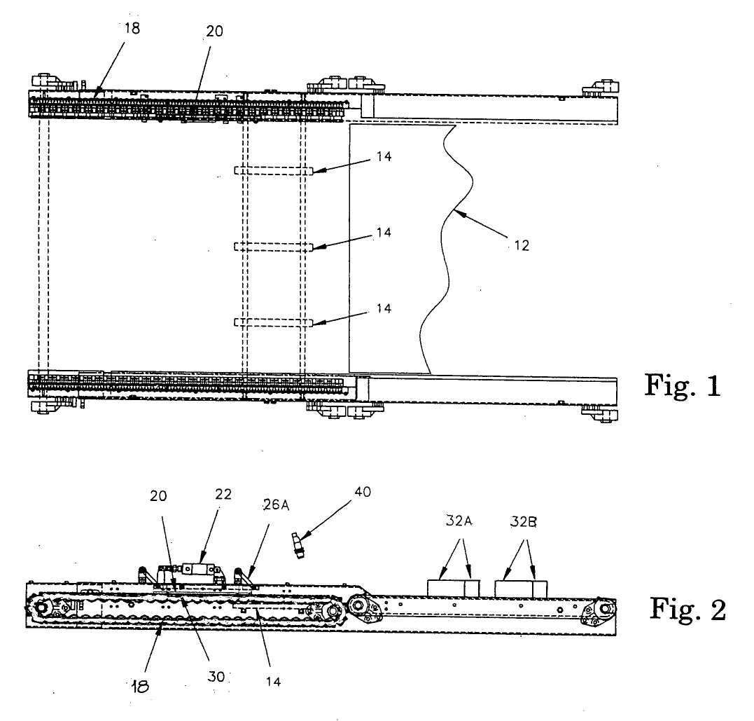

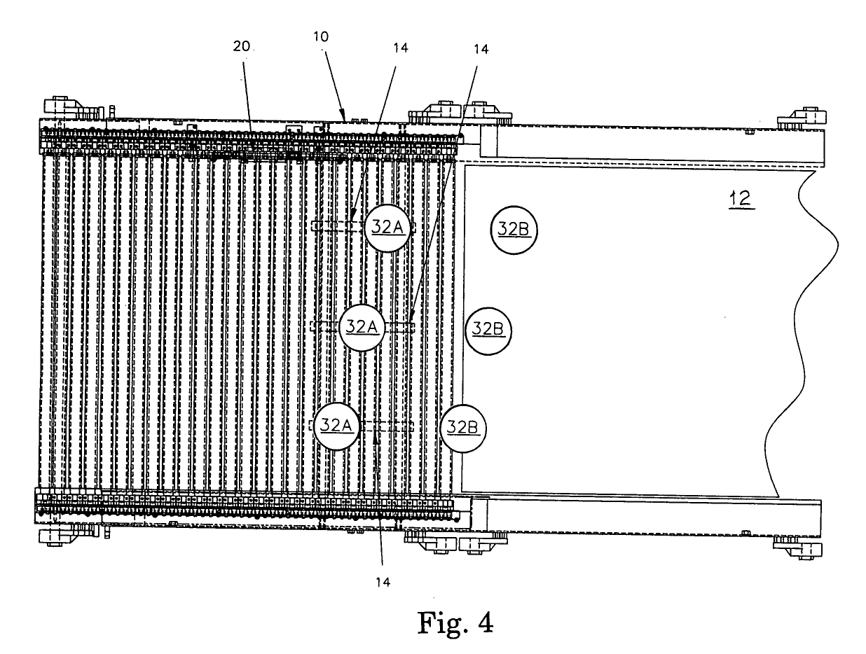

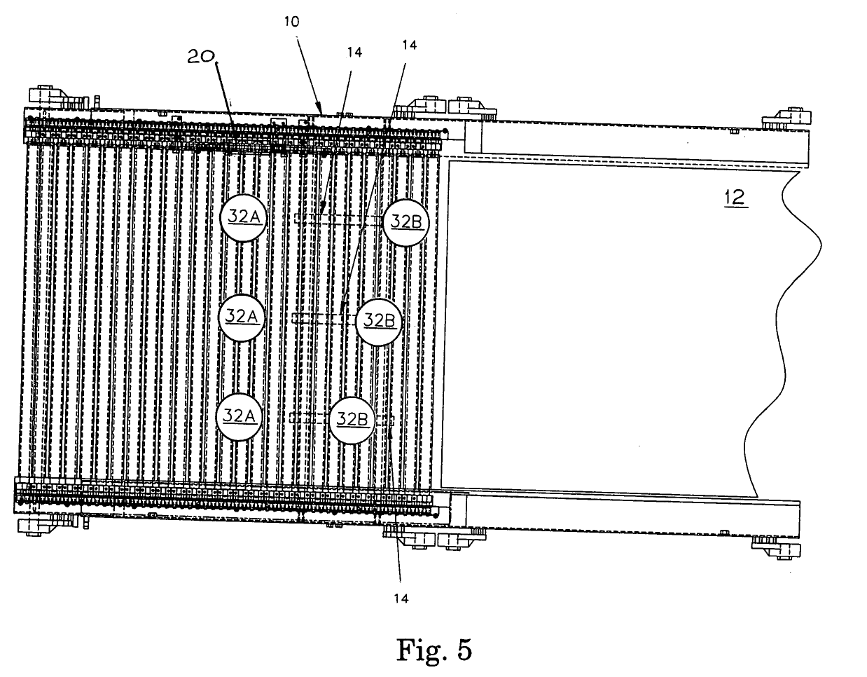

Referring to FIGS. 1-5, wherein like numerals indicate like elements throughout, a preferred embodiment of an alignment conveyor 10 is shown and generally designated 10. Briefly stated, the alignment conveyor 10 allows rows of products 32A, 32B transported by the conveyor to be generally aligned in a side-by-side fashion on the conveyor without necessitating the temporary interruption of the conveyor's operation. The conveyor 10 can be a stand alone conveyor or a component that forms an alignment station in a larger system. Existing conveyor systems can readily be retrofit to include the alignment conveyor 10 of the present invention as an alignment station.

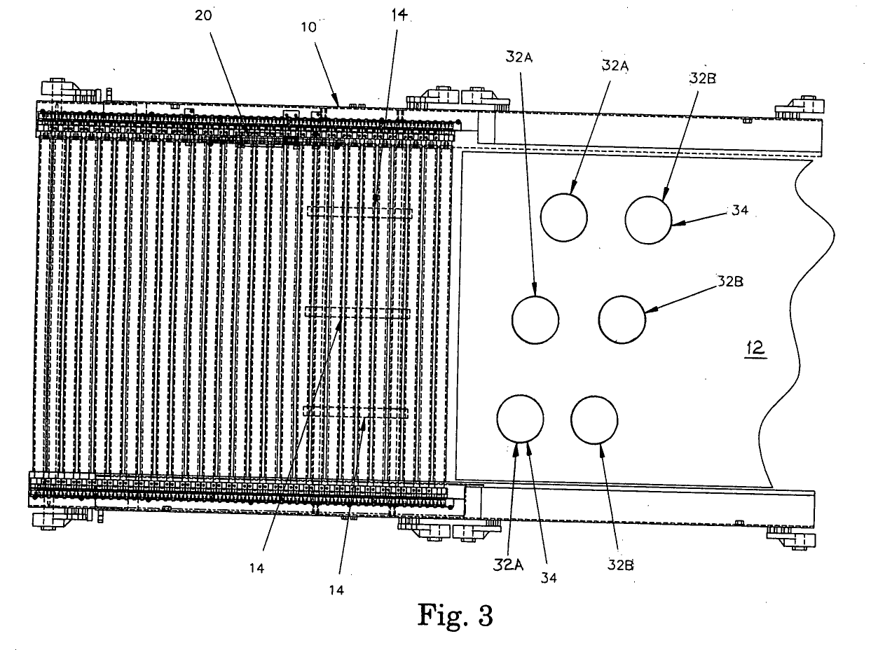

The alignment conveyor 10 is preferably formed by a plurality of free rolling rollers 16 having sufficient width to hold a row of products 32A, 32B in a generally side-by-side arrangement. The rollers 16 are set between two chain drives 18 and connected together to define a conveyor path. The chain drives 18 transport the rollers 16 in a direction of the conveyor path in a first, or forward direction (i.e. generally leftward as shown in FIGS. 1 and 2). Other mechanisms known to those skilled in the art for carrying free rolling rollers along a conveyor path can also be used and would be understood to fall within the scope of the term “chain drives” as used herein regardless of the specific free roller support mechanism used.

A preferred embodiment of the alignment conveyor 10 uses a deceleration mechanism 20 which includes, a rack # that is moveable to engage an upper contact area of pinions connected to the rollers in the downstream area of the alignment region. The rack # may be linked to an actuator 22, so that when the actuator 22 is actuated the deceleration rack # rotates generally upwardly away from the pinions. The deceleration rack # moves generally upwardly about first and second pivots 24a, 24b which are connected to the deceleration rack # via first and second links 26a, 26b respectively. Other mechanisms, known to those skilled in the art, for moving a rack # to an engaged position can also be used and would be understood to fall within the scope of the invention. The rack # contacting the pinions causes counter-rotation of rollers 16 (indicated by arrows in FIG. 2), deceleration product 32A contacting the rollers 16 in the alignment region.

Another preferred embodiment of the alignment conveyor 10 uses a deceleration mechanism that includes a rubber coated strut linked to an actuator for movement between a disengaged and engaged position. When the rubber coated strut is in the engaged position it is in contact with the rollers at the product supporting surface located in the downstream area of the alignment region causing the rollers to rotate in the opposite direction as the conveyor is moving.

In the preferred embodiment of the alignment conveyor 10, an acceleration mechanism is also preferably provided and includes a rubber coated strut which is fixed in an engaged position contacting a lower surface of the rollers in the upstream area of the alignment region. The acceleration rack 14 can also be provided as moveable between a disengaged and engaged position, where the rack 14 engages the lower contact area the rollers in the upstream area of the alignment region. Alternatively, the rack 14 can include teeth and contact the pinions.

The term “rubber coated” can mean, coated with either rubber, or non rubber compositions, so long as the coating composition includes frictional properties similar to rubber for the purposes of rotating the rollers.

The alignment conveyor 10 according to the present invention aligns products by transporting the products 32A, 32B down a conveyor path formed by free rolling rollers 16 having sufficient width to hold rows of products 32 to be conveyed in a generally side-by-side arrangement. Then, using the deceleration mechanism, rotating the rollers in the downstream area of the alignment region in a direction opposite to the direction of travel of the conveyor path. A photogate 40 or other sensing means can be used to trigger the deceleration mechanism when products arrive in the down stream area. The rollers are rotated until all products in the row are aligned in a side-by-side arrangement. Then the deceleration mechanism is then disengaged from the rollers and the aligned row of products is allowed to continue traveling on the conveyor path. The process repeats when the next row of products arrives in the downstream area of the alignment region.

In a preferred method, the alignment conveyor according to the present invention separates the products to be aligned from the standard flow of products before their arrival in the downstream area of the alignment region by using the acceleration mechanism to rotate the rollers in the same direction as the conveyor path travels.

While the products 34 shown in FIGS. 3-5 are generally cylindrical, those of ordinary skill in the art will appreciate that any shaped product 34 can be transported by the alignment conveyor without departing from the scope of the present invention. Additionally, those skilled in the art will appreciate that depending upon the forward momentum and size of the individual products 34, the general side-by-side alignment of the product 34 may occur at different points within the deceleration region.

When differently sized and weighted products are included in a single row, the alignment of the products may not necessarily result in the front edges of the products 34 being perfectly aligned laterally side-by-side with each other. However, if the same mix of products is used in each row, the alignment will be consistent between the rows.

It is recognized by those skilled in the art that changes may be made to the above described embodiments of the invention without departing from the broad inventive concept thereof. For example, the structure of the deceleration mechanism can be varied as long as the rollers 16 within the deceleration region are imparted with the appropriate rotation. Similarly, the structure of the acceleration racks 14 can be varied as long as the rollers 16 in the acceleration region are imparted with a suitable rotation. While a preferred embodiment of a roller conveyor is shown, any conveyor 12 having free rolling rollers can be eliminated and a roller conveyor may be used throughout the entire processing of the products 34. It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. An alignment conveyor adapted to generally align a row of products in a side-by-side fashion, comprising:
a plurality of free rolling rollers, having sufficient width to hold a row of products in a generally side-by-side arrangement, and connected together to define a conveyor path;
a conveyor mechanism for transporting the free rolling rollers in a first direction, at a first speed;
an alignment region located along the conveyor path including an acceleration mechanism located in an upstream area; and a deceleration mechanism located in a downstream area;
the acceleration mechanism which rotates at least some of the rollers, located in an upstream area of the alignment region, so that a product supporting portion of the rollers moves in the first direction to accelerate the products to a speed faster than the first speed; and
the deceleration mechanism moveable from a first disengaged state to a second engage state to rotate the rollers, located in the downstream area of the alignment region, so that the product supporting portion of the rollers moves in a second direction, opposite to the first direction, to decelerate the products to a speed slower than the first speed.

2. An alignment conveyor of claim 1, wherein the deceleration mechanism comprises:
a rack that is movable from a first, disengaged position, to a second, engaged position, where the rack engages an upper contact area of pinions connected to the rollers in the downstream area of the alignment region.

3. An alignment conveyor of claim 1, wherein the acceleration mechanism comprises:
a rack that is fixed in an engaged position, where the rack engages a lower contact area of pinions connected to the rollers in the upstream area of the alignment region.

4. An alignment conveyor of claim 1, wherein the acceleration mechanism comprises:
a rack that is moveable from a first, disengaged position, to a second engaged position, where the rack engages a lower contact area of pinions connected to the rollers in the upstream area of the alignment region.

5. An alignment conveyor of claim 1, wherein the deceleration mechanism comprises:
a rubber coated strut linked to an actuator for movement from a first, disengaged position, wherein the rubber coated strut is not in contact with the rollers, to a second position, wherein the rubber coated strut is in contact with the product engaging surface of the rollers located in the downstream area of the alignment region.

6. An alignment conveyor of claim 1, wherein the acceleration mechanism comprises:
a rubber coated strut which contacts a lower surface of the rollers located in the upstream area of the alignment region.

7. An alignment conveyor of claim 6, wherein the rubber coated strut is linked to an actuator for movement from a first disengaged position, wherein the rubber coated strut is not in contact with the rollers, to a second position, wherein the rubber strut is in contact with the lower surface of the rollers located in the upstream area of the alignment region.

8. A method of aligning rows of products on a conveyor comprising:
providing a plurality of free rolling rollers connected together to define a conveyor path having sufficient width to hold rows of products to be conveyed in a first direction in a generally side-by-side arrangement;
transporting a first row of the products on the conveyor in the first direction;
rotating the rollers moving through a downstream area of an alignment region so that the product supporting surface of the rollers moves in a second direction, opposite to the first direction, until the products in the first row are in an aligned side-by-side arrangement; and
after alignment, allowing the first row of products aligned in a side by side arrangement to continue in the first direction down the conveyor path.

9. The method of aligning rows of products on a conveyor of claim 8, further comprising:
rotating the rollers moving through an upstream area in the alignment region so that the product supporting surface of the rollers moves in the first direction, accelerating the first row products located thereon to a higher speed than the speed of the roller conveyor path to widened a distance from a second row of products prior to the first row of products entering the downstream area.

10. The method of aligning rows of products on a conveyor of claim 8, wherein the process repeats, after the 1st row of products continues in the 1st direction, with the second row of products.

11. The alignment conveyor of claim 1 further comprising a photo gate sensor at the start of the down stream area which triggers the rotation of the deceleration mechanism when product arrives in the downstream area.
